(19) United States
(12) Patent Application Publication
(10) Pub. No.: US 2008/0122261 A1
(43) Pub. Date: May 29, 2008

(54) Hood of a vehicle

(76) Inventor: Kyung Dug Seo, Hwaseong-city (KR)

Correspondence Address: MORGAN, LEWIS & BOCKIUS LLP (SF), One Market, Spear Street Tower, Suite 2800, San Francisco, CA, 94105, US

(21) Appl. No.: 11/646,075

(22) Filed: Dec. 26, 2006

(30) Foreign Application Priority Data
Nov. 28, 2006 (KR) 10-2006-0118469

(51) Int. Cl. B62D 25/10

(52) U.S. Cl. 296/193.11

(57) ABSTRACT

A vehicle hood includes a hood inner panel; a hood outer panel attached to the hood inner panel; a subframe attached to the hood inner panel; and at least one auxiliary frame disposed at the subframe and attached to the hood inner panel. The subframe is disposed in a substantially straight line across a lateral direction of the hood inner panel. Each of the auxiliary frames is substantially perpendicular to the subframe. Each of the auxiliary frames includes a pair of lateral plates disposed at a slant with respect to a width of the auxiliary frame, the pair of lateral plates defining a groove; and combining portions for attaching the auxiliary frame to the subframe, the combining portions extending from the pair of lateral plates. The hood outer panel, the subframe, and the vertical frames are attached to the hood inner panel by hemming.

### CROSS-REFERENCE TO RELATED APPLICATION

This application claims priority to and the benefit of Korean Patent Application No. 10-2006-0118469 filed in the Korean Intellectual Property Office on Nov. 28, 2006, the entire contents of which are incorporated herein by reference.

### BACKGROUND OF THE INVENTION

(a) Field of the Invention

The present invention relates to a vehicle hood. More particularly, the present invention relates to a hood that may reduce an injury of a pedestrian at a collision with a vehicle.

(b) Description of the Related Art

Various safety regulations are applied to a vehicle hood in order to reduce an injury of a pedestrian at a collision with a vehicle. In order to satisfy such regulations, the hood panel should show a good absorption of impact. In addition, since the hood panel is deformed toward the engine in an accident, a sufficient gap should be provided between the hood and the engine.

A conventional hood inner panel has an A-shaped base frame and a plurality of auxiliary frames. Such a structure provides high strength of a hood in collisions but causes serious injuries to pedestrians.

In order to reduce pedestrian injuries, an inner or outer panel of the hood may be made thinner. However, this results in a loss of strength of the hood. Furthermore, considering that the inner panel is formed as a single piece by pressing, forming different thicknesses of hood inner panels for different vehicle models is very cost-consuming.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a vehicle hood that minimizes pedestrian injuries at a collision while providing sufficient strength of the vehicle hood.

An exemplary embodiment of the present invention provides a vehicle hood including: a hood inner panel; a hood outer panel assembled to the hood inner panel by hemming; a subframe assembled to the hood inner panel by hemming; and a plurality of auxiliary frames disposed at the subframe, and each of the auxiliary frames being assembled to the hood inner panel by hemming.

The subframe may be formed in a substantial straight line across the hood inner panel.

Each of the plurality of auxiliary frames may be substantially perpendicular to the subframe.

Each of the auxiliary frames may include: a pair of lateral plates that slant with respect to the width of the auxiliary frame and forms a groove; and combining portions for being combined with the subframe, the combining portions being extended from edges of the pair of lateral plates.

### BRIEF DESCRIPTION OF THE DRAWINGS

FIG. 1 is an exploded perspective view of a vehicle hood according to an exemplary embodiment of the present invention.

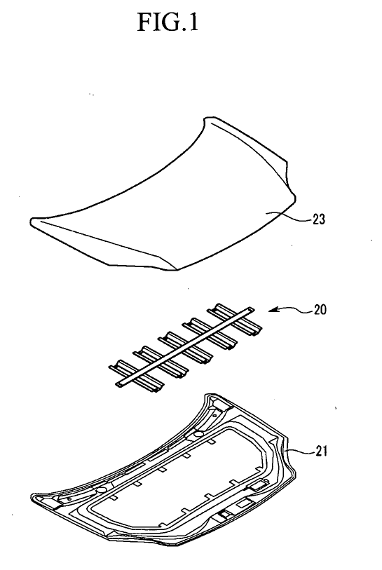

FIG. 2 shows a hood inner panel combined with a hood inner panel module according to an embodiment of the present invention.

FIG. 3 is a cross-sectional view along line A-A of FIG. 2.

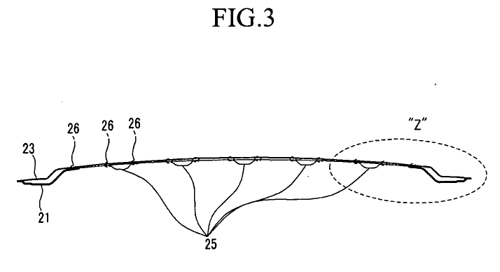

FIG. 4 is an enlarged view of portion Z of FIG. 3.

FIG. 5 is a cross-sectional view along line B-B of FIG. 2.

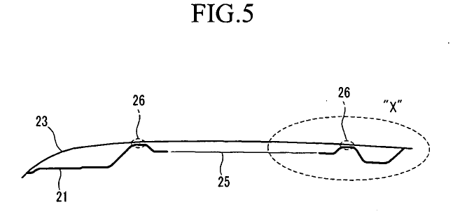

FIG. 6 is an enlarged view of portion X of FIG. 3.

### DETAILED DESCRIPTION OF THE PREFERRED EMBODIMENTS

An exemplary embodiment of the present invention will hereinafter be described in detail with reference to the accompanying drawings.

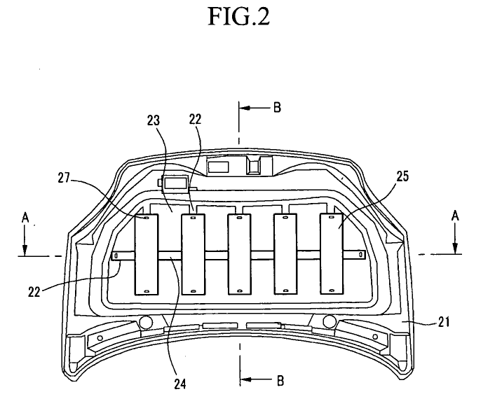

A vehicle hood according to an exemplary embodiment of the present invention includes a hood inner panel 21, a hood outer panel 23, and a hood inner panel module 20. The hood inner panel 21 may be formed by pressing. The hood outer panel 23 may be assembled to the hood inner panel 21 by hemming (refer to hemming assembled portions 22 shown in FIG. 2).

The hood inner panel module 20 includes a subframe 24 and a plurality of auxiliary frames 25. The subframe 24 is assembled to the hood inner panel 21 by hemming. The auxiliary frames 25 are assembled to the hood inner panel 21 by hemming, and are spaced apart from one another.

The subframe 24 and the auxiliary frames 25 are formed separately from the hood inner panel 21, and then they are assembled to the hood inner panel 21. The subframe 24 is disposed in a substantially straight line across the hood inner panel 21. Each of the auxiliary frames is substantially perpendicular to the subframe.

Hemming flange holes 27 are provided at ends of the auxiliary frame 25 and the subframe 24 so as to enable the hemming assembly.

The number of auxiliary frames 25 may be chosen according to the hood design requirements.

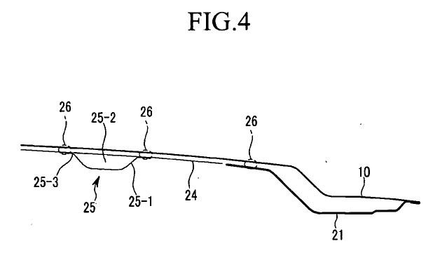

Referring to FIG. 4, a groove 25-2 is provided on the auxiliary frame 25 by lateral plates 25-1 that slant with respect to the width of the auxiliary frame 25. Combining portions 25-3 for attaching the auxiliary frames 25 to the subframe 24 are extended from edges of the pair of lateral plates 25-1.

The auxiliary frames 25 are adhered to the hood outer panel 23 by a mastic sealer 26. The hood inner panel 21 and the subframe 24 are combined by a hemming structure (refer to FIG. 4).

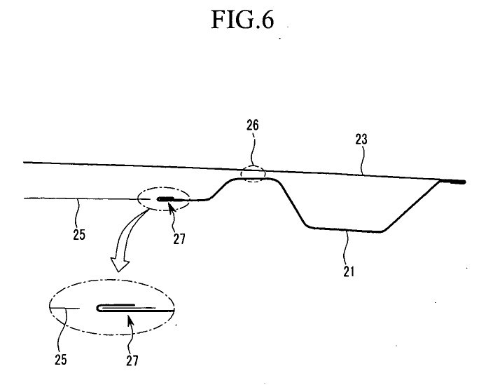

Both ends of the auxiliary frame 25 are combined with the hood inner panel 21 by a hemming structure. The hood inner panel 21 and the hood outer panel 23 are adhered to each other by the mastic sealer 26 (refer to FIG. 6).

The auxiliary frames 25 may be welded to the subframe 24.

In some countries, hood regulations are stringent, and for others, this is not the case. For some types of vehicles, protecting pedestrians is critical, and for other types of vehicles, other features may be more important. With respect to such a variety of cases, the number and the thickness of the auxiliary frame 25 may be easily altered considering the characteristics of the vehicles, and thus design factors for each type of vehicle may be satisfied with a low cost.

According to an exemplary embodiment of the present invention, a pedestrian colliding with a vehicle is protected, and at the same time, a variety of hoods appropriate for variety of vehicle characteristics may be fabricated at a low cost.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A vehicle hood comprising:
a hood inner panel;
a hood outer panel attached to the hood inner panel;
a subframe attached to the hood inner panel; and
at least one auxiliary frame disposed at the subframe and attached to the hood inner panel.

2. The hood of claim 1, wherein the subframe and the auxiliary frames are made separately from the hood inner panel.

3. The hood of claim 1, wherein the subframe is disposed in a substantially straight line across a lateral direction of the hood inner panel.

4. The hood of claim 1, wherein each of the auxiliary frames is substantially perpendicular to the subframe.

5. The hood of claim 1, wherein each of the auxiliary frames comprises:
a pair of lateral plates disposed at a slant with respect to a width of the auxiliary frame, the pair of lateral plates defining a groove; and
combining portions for attaching the auxiliary frame to the subframe, the combining portions extending from the pair of lateral plates.

6. The hood of claim 1, wherein the hood outer panel is attached to the hood inner panel by hemming.

7. The hood of claim 1, wherein the subframe is attached to the hood inner panel by hemming.

8. The hood of claim 1, wherein the vertical frames are attached to the hood inner panel by hemming.
